(19) United States
(12) Patent Application Publication
(10) Pub. No.: US 2017/0003167 A1
(43) Pub. Date: Jan. 5, 2017

(54) PATTERNING APERTURE SLIT FOR SPECTROMETRY

(71) Applicant: Ocean Optics, Inc., Dunedin, FL (US)

(72) Inventor: Paul W. Ave, Orlando, FL (US)

(21) Appl. No.: 14/834,631

(22) Filed: Aug. 25, 2015

Related U.S. Application Data
(60) Provisional application No. 62/045,052, filed on Sep. 3, 2014.

(51) Int. Cl. G01J 3/04; G01J 3/02

(52) U.S. Cl. CPC G01J 3/04; G01J 3/0297

(57) ABSTRACT

A device for improving the removal of stray light interference in a spectrometer using an aperture slit with a predefined grid pattern incorporated into it to create periodic shadowing allowing the identification of the desired signal and removal of stray light is disclosed.

### CROSS-REFERENCE TO RELATED APPLICATION

The present application claims the benefit of previously filed co-pending Provisional Patent Application Ser. No. 62/045,052 filed on Sep. 3, 2014.

### FIELD OF THE INVENTION

The device of this disclosure belongs to the field of manufacture of spectrometers. More specifically it is a new patterned aperture slit to improve stray light interference avoidance.

### BACKGROUND OF THE INVENTION

It is well known by those skilled in the art that the accuracy of spectroscopic measurements are hindered by what is known as stray light. A new approach to suppression of interfering stray light was discussed in the paper, “Stray Light Suppression in Spectroscopy Using Periodic Shadowing”, by Kristensson et al. that was published 7 Apr. 2014 in Vol. 22, No. 7, Optics Express 7711 through 7721 by the Optical Society of America.

This new method of stray light suppression involved the placing of a Ronchi grid in front of the entrance slit creating periodic shadowing with a given spatial frequency and phase along the slit direction. The stray light is unable to maintain this structure and thus the signal to be studied can be identified and separated from the stray light by a detection algorithm well known to those skilled in the art.

The novel improvement in periodic shadowing of this disclosure involves the use of a prefabricated slit which has a predefined grid pattern incorporated into the slit.

### BRIEF SUMMARY OF THE INVENTION

This invention is a device for improving the removal of stray light interference in a spectrometer using an aperture slit with a predefined grid pattern incorporated into it to create periodic shadowing allowing the identification of the desired signal and removal of stray light.

### BRIEF DESCRIPTION OF THE DRAWINGS

For a fuller understanding of the nature and objects of the invention, reference should be made to the following detailed description, taken in connection with the accompanying drawings, in which:

FIG. 1 shows a diagram of one embodiment of the Patterning Aperture Slit in a typical aperture made for mounting in a spectrometer;

FIG. 2 shows a front view diagram of one embodiment of the Patterning Aperture Slit;

FIG. 3 shows a perspective view diagram of one embodiment of the Patterning Aperture Slit; and,

FIG. 4 shows an image of the Patterning Aperture Slit creating periodic shadowing.

### DESCRIPTION OF THE PREFERRED EMBODIMENT

As discussed above a new method of stray light suppression involving the placing of a Ronchi grid in front of the entrance slit creating periodic shadowing with a given spatial frequency and phase along the slit direction has been disclosed in the prior art. The stray light is unable to maintain this structure and thus the signal to be studied can be identified and separated from the stray light by a detection algorithm well know to those skilled in the art.

The novel device of this disclosure creating the periodic shadowing involves the use of a prefabricated slit which has a predefined grid pattern incorporated into it.

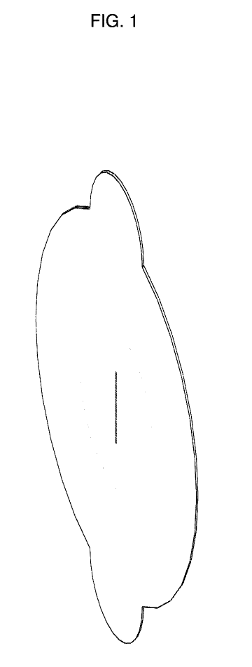

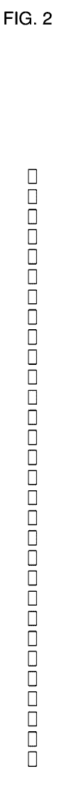

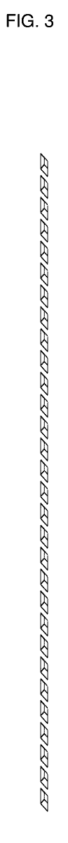

As shown in FIGS. 1, 2, and 3, this device is constructed by cutting the aperture slit in a predefined grid pattern which, when used in spectroscopy, creates a periodic shadowing of the light signal desired to be measured and thus allows for the identification and removal of stray light by use of a processing algorithm known to those skilled in the art since the stray light will not adhere to the shadowing pattern.

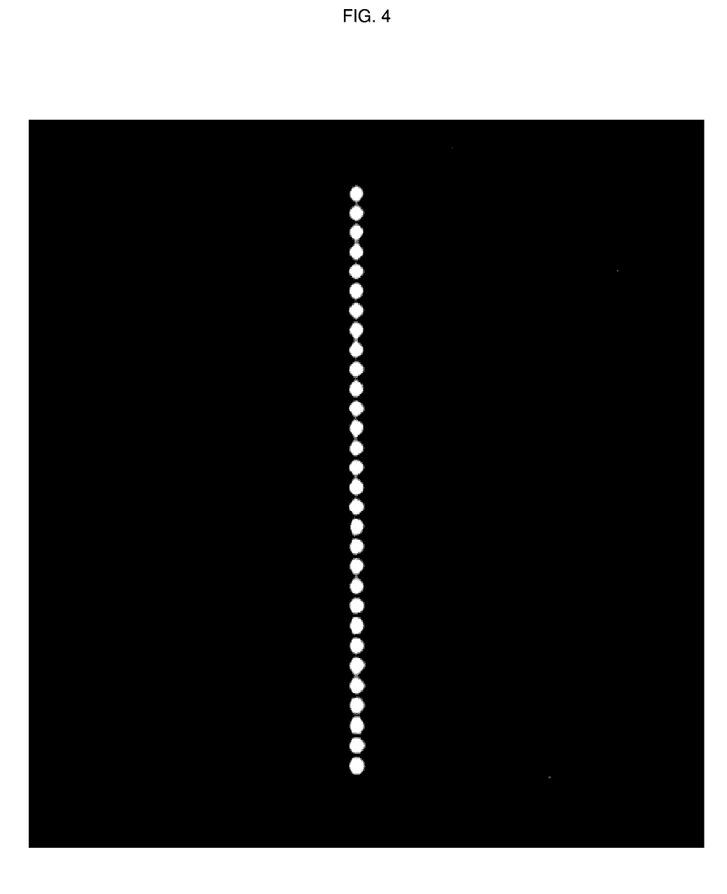

FIG. 4 shows an image of the periodic shadowing produced by the patterning aperture slit produced in accordance with FIGS. 1, 2, and 3.

Since certain changes may be made in the above described patterning aperture slit without departing from the scope of the invention herein involved, it is intended that all matter contained in the description thereof or shown in the accompanying figures shall be interpreted as illustrative and not in a limiting sense.

What is claimed is:

1. A patterning aperture slit for the removal of stray light interference from a light signal being measured by a spectrometer comprising:
said patterning aperture slit cut in a predefined grid pattern extending the length of said aperture slit; and,
said predefined grid pattern creating a periodic shadowing of said light signal being measured allowing for the identification of said light signal being measured and removal of stray light interference.

2. A method the removal of stray light interference from a light signal being measured by a spectrometer using a patterning aperture slit comprising:
first determining what light signal is being measured by the spectrometer;
then determining what grid pattern would create periodic shadowing of said light signal being measured;
then cutting said patterning aperture slit in said determined grid pattern extending the length of said shaped aperture slit; and,
using said patterning aperture slit in a spectrometer, creating a periodic shadowing of said light signal being measured, identifying said light signal being measured, and removing stray light interference.
